(19) United States
(12) Patent Application Publication
(10) Pub. No.: US 2009/0269719 A1
(43) Pub. Date: Oct. 29, 2009

(54) RADICULAR PIVOT WITH A VARIABLE DEPTH PROGRESSIVE THREAD ALLOWING THE REMOVAL THEREOF

(75) Inventor: Pierre Malek, Key Biscayne, FL (US)

Correspondence Address: HARNESS, DICKEY & PIERCE, P.L.C., P.O. BOX 828, BLOOMFIELD HILLS, MI, 48303, US

(73) Assignee: Pierre Malek, Key Biscayne, FL (US)

(21) Appl. No.: 12/424,033

(22) Filed: Apr. 15, 2009

(30) Foreign Application Priority Data
Apr. 16, 2008 (FR) 0852548

(51) Int. Cl. A61C 8/00

(52) U.S. Cl. 433/174

(57) ABSTRACT

The present application relates to a radicular pivot including a rod having a threaded part wherein the distance between the internal conical envelope going through the roots of the threads, on the one hand, and the external conical envelope going through the crests of the threads increases towards the apical end, at least on a proximal part of the length of the thread.

### CROSS-REFERENCE TO RELATED APPLICATION

This application claims priority to French Application No. 0852548, filed Apr. 16, 2008, which is incorporated by reference herein.

### BACKGROUND AND SUMMARY

The present invention relates to the field of tooth pivots. A tooth pivot is composed of a three to twenty millimeters long cylindrical structure, which can be crowned. The tooth pivot is intended to be anchored at the level of the root of the tooth, using dental cement. The pivot can have an external thread and be substantially vertically screwed in the region of the radicular canal, so as to form a removable link between the anchoring pivot and the root of the tooth.

The patent EP0305934 is known, which describes a tooth pivot having a rod, with the apical part of the pivot being cylindrical, which is followed by a tapered cervical part extended by a head adjacent to the tapered part. The head is used for restoring, in a composite material or an amalgam, a stump intended to receive a tooth crown. The section of the head is not circular which better matches the shape of a natural tooth than if it were of a circular shape, but it requires to be able to orient the pivot when it is positioned in the radical canal after an endodontic preparation thereof, depending on the dental arch.

Pivots having a threaded rod on a part of the length thereof are also known. The American patent U.S. Pat. No. 4,334,865 describes such a pivot having a threaded end, which makes it possible to anchor it, using dental cement or a sealing paste. This pivot can be made of titanium or of a synthetic material.

The problem arising from such pivots is that of the removal thereof. As a matter of fact, the stresses which must be exerted on the pivot for the removal thereof are high, for a pivot of a known type, and they must be exerted in a constant way, until the pivot is removed. Such stresses can result in the rupture of the root.

The present invention aims at remedying such drawback by providing a threaded pivot allowing a removal thereof, with limited stresses, and more particularly allowing to substantially limit the stresses after a first partial rotation causing the unsealing thereof. For this purpose, the invention, in its broadest sense, relates to a radicular pivot composed of a rod having a threaded part characterized in that the distance between the internal conical envelope going through the roots of the threads, on the one hand, and the external conical envelope going through the crests of the threads increases towards the apical end, on at least a proximal part of the length of the thread. Advantageously, at least one of said envelopes has a section decreasing towards the apical end.

Preferably both internal and external envelopes have a section decreasing towards the apical end. According to a particular variant, the pivot has, on the conical apical part thereof, an incomplete thread, the depth of which increases towards the head. According to another variant, the pivot according to the invention has a smooth conical distal end.

Advantageously, the thread is a trapezoid section thread. According to a variant, the thread is a semi-circular, square or triangular section thread. According to a first embodiment, the thread is a positive thread. Positive thread means a thread, the edges of which have a section greater than the provided chamber and thus engage in the endodontic wall. According to another embodiment, the thread is a negative thread. Negative thread means a thread, the edges of which have a section smaller than the provided chamber and thus come to the surface of the endodontic wall.

### BRIEF DESCRIPTION OF THE DRAWINGS

The invention will be better understood upon reading the detailed following description and referring to the appended drawings wherein:

FIG. 1 shows a diagrammatic view of a pivot according to the invention; and

FIG. 2 shows a front view of a second exemplary embodiment of such a pivot.

### DETAILED DESCRIPTION

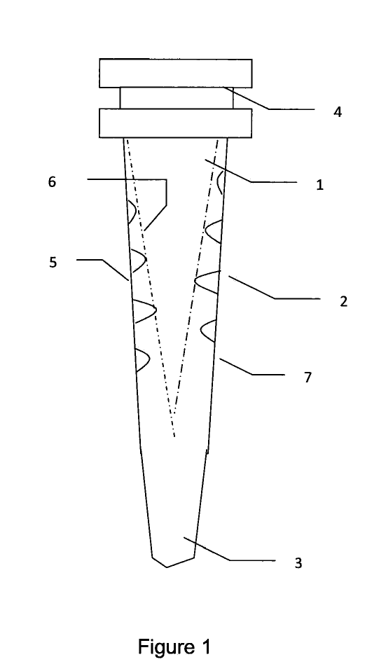

FIG. 1 shows a diagrammatic view of a pivot according to the invention. It is composed of a rod 1 made of titanium or glass fiber or carbon with a threaded intermediate zone 2. The general shape of the rod 1 is conical, with a section decreasing towards the apical end 3. The head 4 shows, in a known way, crown anchoring means.

The threaded part 2 has a helicofdal thread, which according to the invention, has a variable depth. On most of the thread, the depth of the threads increases towards the apical end. However, according to a variant described in FIG. 1, the thread has an incomplete thread 7, i.e. the part of the thread which is closer to the apical end 3, where the depth of the thread increases towards the head.

The external envelope 5 of the edges of the upper part of the thread 2 has the shape of a truncated cone, the section of which decreases toward the apical end 3. The external envelope 5 is the conical surface going through the crests of the threads, in the upper part of the pivot. It may be cylindrical, with a constant or conical section, with a section decreasing towards the apical end 3.

The internal envelope 6 of the edges of the upper part of the thread 2 also has the shape of a truncated cone the section of which decreases towards the apical end 3. The internal envelope 6 is the conical surface going through the roots of the threads, in the upper part of the pivot. It is conical, with a section decreasing towards the apical end 3 at least up to the incomplete thread 7.

According to the invention, the slope of the external envelope 5 is inferior to the slope of the internal envelope 6, in other words, the radial distance between the external envelope 5 and the internal envelope 6 increases towards the apical end 3 at least up to the incomplete thread 7 where the depth of the thread decreases. This embodiment makes it possible to reduce the stresses which are exerted between the pivot and the root during the removal: when the pivot is unlocked, by the start of the rotation, the anchoring of the sealing paste is quickly reduced because of the particular configuration of the threads.

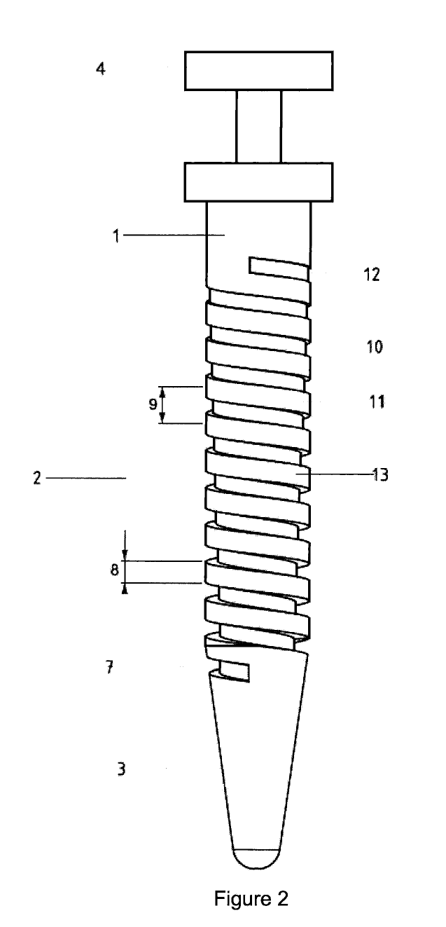

FIG. 2 shows a front view of a detailed exemplary and non limitative embodiment. The pivot has a total length of 10.5 millimetres. The crowned head 4 has a length of 2.30 millimetres.

The section of the rod 1, at the proximal end opposite the apical end 3, amounts to 1.40 millimetres. This part of the rod is cylindrical, with a constant section. At the apical end 3 thereof, the section decreases to have the general shape of a cone having a slope of about 3°, the end of which is ogival or semi-spherical.

The threaded part 2 has a pitch 9 of 0.5 millimetres. The width of the roots of the threads amounts to 0.14 millimetres, and the width of the protruding part 8 of the threads amounts to 0.3 millimetres. The shape of the thread is substantially trapezoidal, with a root 10 having a plane section and a protruding part 11, 13 having a plane section. The invention is not limited to trapezoidal section threads and extends to any type of threads.

The depth of the threads increases from the proximal end 12 located 0.5 millimetres away from the crowned head 4, to the beginning of the incomplete thread 7. The depth varies, and increases towards the apical end 3, between a null depth and a depth of one millimetre, before decreasing at the level of the incomplete thread 7. On the contrary, the external envelope going through the crests of the threads has a constant section or a section continuously decreasing on the whole length of the thread, towards the apical end 3.

The invention claimed is:

1. A radicular pivot comprising a rod having a threaded part wherein the distance between the internal conical envelope going through the roots of the threads, on the one hand, and the external conical envelope going through the crests of the threads increases towards the apical end, on at least a proximal part of the length of the thread.

2. A radicular pivot according to claim 1, wherein both external and internal envelopes of the thread have a section decreasing towards the apical end.

3. A radicular pivot according to claim 1, wherein the external envelope of the thread has a constant section, and wherein the internal envelope of the part of the thread upstream of the incomplete thread has a section decreasing towards the apical end.

4. A radicular pivot according to claim 1, wherein it has a distal incomplete thread wherein the depth of the thread increases towards the head.

5. A radicular pivot according to claim 1, wherein it has a smooth conical distal end.

6. A radicular pivot according to claim 1, wherein the thread is a trapezoid section thread.

7. A radicular pivot according to claim 1, wherein the thread is a semi-circular section thread.

8. A radicular pivot according to claim 1, wherein the thread is a triangular section thread.

9. A radicular pivot according to claim 1, wherein the thread is a square section thread.

10. A radicular pivot according to claim 1, wherein the thread is a positive thread.

11. A radicular pivot according to claim 1, wherein the thread is a negative thread.
